(19) United States
(12) Patent Application Publication
(10) Pub. No.: US 2005/0031881 A1
(43) Pub. Date: Feb. 10, 2005

(54) Laminated film comprising a fluororesin

(76) Inventor: Yoshihiko Nishio, Nagahama-shi (JP)

Correspondence Address: PITNEY HARDIN LLP, 7 TIMES SQUARE, NEW YORK, NY, 10036-7311, US

(21) Appl. No.: 10/931,494

(22) Filed: Sep. 1, 2004

(30) Foreign Application Priority Data
Feb. 27, 2002 (JP) 2002-51910
Sep. 2, 2003 (JP) 2003-246035

(51) Int. Cl. B32B 27/36; B32B 1/00

(52) U.S. Cl. 428/483; 428/336; 428/421; 428/422; 428/910

(57) ABSTRACT

A laminated film comprising a drawn polyester film and a tetrafluoroethylene-hexafluoropropylene-vinylidene fluoride ternary copolymer film laminated on at least one side of the drawn polyester film. The film can be made by extrusion lamination and suitable as a carrier film.

### CROSS REFERENCE

This application is based on Japanese Patent Application Laid-Open No. 2003-246035 published on Sep. 2, 2003, the contents of which are hereby incorporated by reference.

### FIELD OF THE INVENTION

The present invention relates to a laminated film comprising a fluororesin film, specifically to that suitable as a carrier film for manufacturing a coating film.

### DESCRIPTION OF THE PRIOR ART

A carrier film is used to make a coating film by applying an adhesive or paint thereon. The carrier film supports the obtained coating film and is peeled off from the coating film when the coating film is used. A fluororesin film or biaxially drawn polyethylene terephthalate (PET) film coated with a silicone compound is hitherto mainly used as the carrier film.

A fluororesin is generally expensive. Therefore, a thinner film is preferred from an economic point of view, but a too much thin film has poor handling property. A fluororesin film thick enough to have a satisfactory handling property tends to have poor precision in thickness. This causes a problem that thickness of a coating film formed on the fluororesin film is not uniform. Further, the fluororesin has poor mechanical strength such as tensile strength and may be torn when stretched in a coating process line.

Meanwhile, a PET film coated with a silicone compound has a disadvantage that a coating film formed thereon is contaminated with the silicone compound.

To solve the above problem, the present inventor invented a laminated carrier film comprising a drawn polyester film and a fluororesin film laminated on at least one side of the drawn polyester film (Japanese Patent Application Laid-Open No. 2002-067241).

The above carrier film is made typically by dry lamination as is a conventional laminated films comprising a fluororesin layer. However, in the dry lamination, foreign bodies are often trapped between film layers. The foreign bodies and voids caused around them tend to spoil appearance of the film. In addition, the dry lamination requires laborsome pretreatment, for example, corona treatment, of surfaces of films to be laminated.

### SUMMARY OF THE INVENTION

The present invention is intended to provide a laminated film which can be prepared without aforesaid problems.

Thus, the present invention is a laminated film comprising a drawn polyester film and a tetrafluoroethylene-hexafluoropropylene-vinylidene fluoride ternary copolymer film laminated on at least one side of the drawn polyester film.

Preferred embodiments of the above invention are as follows:

The laminated film described above, wherein a film comprising another fluororesin than the ternary copolymer is further laminated on said ternary copolymer film.

The laminated film described above, wherein said film comprising the other fluororesin is a film comprising a tetrafluoroethylene-ethylene copolymer or a tetrafluoroethylene-hexafluoropropylene copolymer.

The laminated film described above, wherein the laminated film has a difference between a maximum thickness and a minimum thickness, R, of 5 μm or smaller, said thickness being measured along a 10 cm-long line starting at an arbitrary point on a surface of the laminated film with a continuous-mode thickness meter provided with a tip having a diameter of 5 mm.

The laminated film described above, wherein said drawn polyester film is a polyethylene terephthalate film having a thickness of from 5 to 1,000 μm and said ternary copolymer film has a thickness of from 2 to 10 μm.

The laminated film described above, wherein said film comprising the other fluororesin is a film comprising a tetrafluoroethylene-hexafluoropropylene copolymer and having a thickness of from 2 to 10 μm.

The laminated film described above, wherein the film has a total thickness of from 10 to 300 μm.

The laminated film described above, wherein a polyethylene film, polypropylene film, or polyester film is further laminated on said ternary copolymer film or the other fluororesin.

Another aspect of the present invention is a carrier film for manufacturing and supporting a coating film comprising the laminated film described above.

Still another aspect of the present invention is a method for preparing a laminated film, comprising a step of extrusion laminating a tetrafluoroethylene-hexafluoropropylene-vinylidene fluoride ternary copolymer on a drawn polyester film.

Preferably, the ternary copolymer is co-extruded together with another fluororesin than the ternary copolymer and laminated on the drawn polyester film.

### BRIEF DESCRIPTION OF THE DRAWING

FIG. 1 is a schematic diagram showing an extrusion lamination method used in the present invention.

### DESCRIPTION OF THE PREFERRED EMBODIMENTS

As the polyester film used in the present carrier film, any known drawn polyester films can be used. Examples of such include films of polyethylene terephthalate, polyethylene naphthalate, polyethylene isophthalate, and polybutylene terephthalate. Among these, films of polyethylene terephthalate are preferred because of their good precision of thickness, thermal properties, mechanical properties, and lower price.

The polyester film preferably has a thickness of 5 to 300 μm, more preferably 25 to 100 μm. If the thickness is smaller than the aforesaid lower limit, a handling property of the carrier film is worse. If it is larger than the aforesaid upper limit, thickness precision of the polyester film is too low to make a carrier film having desired precision of thickness and, in addition, manufacturing costs and the amount of waste may be larger.

The tetrafluoroethylene-hexafluoropropylene-vinylidene fluoride ternary copolymer (THV) used in the present invention is preferably composed of 30 to 70 wt % of tetrafluoroethylene, 1 to 30 wt % of hexafluoropropylene and 10 to 50 wt % of vinylidene fluoride, based on a total weight of the copolymer. For a two-layer film of THV/PET, adhering or releasing property suitable to an object to which the film is to be applied may be provided by adjusting a composition of the THV, especially fluorine content. When a film comprising another fluororesin than THV is to be laminated on the THV layer, the THV is preferably composed of 40 to 60 wt % of tetrafluoroethylene, 10 to 25 wt % of hexafluoropropylene and 20 to 45 wt % of vinylidene fluoride.

The THV film preferably has a thickness of from 2 to 10 μm, more preferably from 2 to 5 μm. If the thickness is smaller than the lower limit, a laminated film may have a defect which is devoid of THV to have a poor release property, due to uneven thickness of a THV film. In a three-layer film comprising a layer of the other fluororesin than THV on the THV layer, such a thin THV film may not sufficiently bind the other fluororesin film and the polyester film. A THV film thicker than the aforesaid upper limit does not give reasonable improvement in film properties, compared to cost increase.

As the other fluororesin than THV used in the present invention, use may be made of poly(tetrafluoroethylene)(PTFE), tetrafluoroethylene- perfluoroalkylvinylether copolymer(PFA), tetrafluoroethylene-ethylene copolymer(ETFE), tetrafluoroethylene-hexafluoropropylene copolymer (FEP), poly(chlorotrifluoroethylene) (CTFE), or poly(vinylidene fluoride) (VdF). Preferably, ETFE is used. The film of the other fluororesin than THV preferably has a thickness of from 2 to 10 μm, more preferably from 3 to 5 μm. If the thickness is smaller than the lower limit, a laminated film may have a defect which is devoid of the other fluororesin to have a poor release property, due to uneven thickness of the film. If the thickness exceeds the upper limit, production costs will increase.

The present laminated film, when used as a carrier film, preferably has a total thickness of from 10 to 300 μm, more preferably from 60 to 300 μm, for uniform thickness.

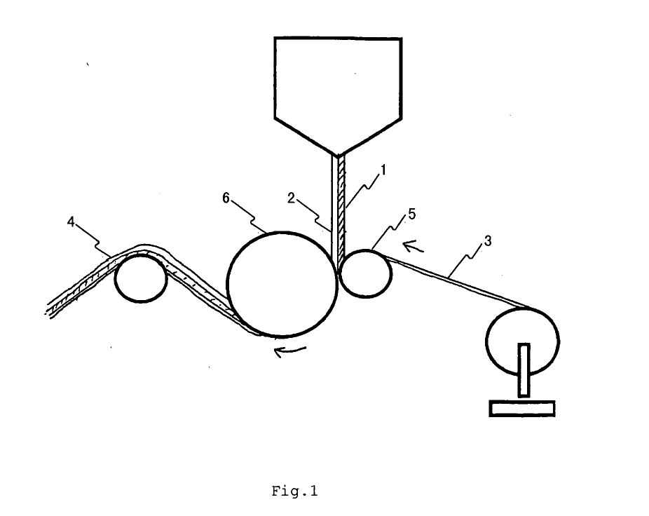

The present film may be prepared by extrusion lamination. Referring to FIG. 1, a three-layer film 4 of the present invention is prepared by co-extruding the THV into film 1 and another fluororesin into film 2 through a T-die at an elevated temperature, for example, of 315 degrees C. The co-extruded films and a the oriented polyester film 3 are pressed with each other, with the THV film 1 facing the polyester film 3, between a nip roll 5 and a quench roll 6. The obtained three-layer film 4 is winded on a roll. Prior to the lamination, the surface of the polyester film is coated with an adhesive such as an acryl-modified adhesive, an isocyanate adhesive, a polyethylene imine adhesive, a polyurethane adhesive, or a silane-coupling agent.

The extrusion lamination process is superior to a dry lamination process in that pretreatment of the fluororesin film such as corona discharge is not required. In addition, a thin fluororesin film can be laminated more easily by extrusion lamination than dry lamination. To dry laminate a thin fluororesin film, the fluororesin is co-extruded together with a polyolefin resin, or is extruded on a transfer film, because such a thin film alone is difficult to handle. After dry laminating the thin fluororesin film on a polyester film, the polyolefin film or the transfer film is peeled off. These laborsome processes are not necessary in the extrusion lamination.

Preferably, a protective film layer, e.g., polyethylene film, is provided on the surface of the THV layer or the other fluororesin layer, i.e., the surface opposite to the one bonded to the PET film. The protective film is peeled off immediately before placing the carrier film on a metal base plate, so that one can keep dust away to provide a coating film with higher thickness precision. As the protective film, any film which can stick to the THV or the other fluororesin film may be used. Examples of such include films of various types of polyethylene, polypropylene, polyester, poly (vinyl chloride), triacetylcellulose, cellophane, polyamide, polycarbonate, aromatic polyamide, polyimide, polyetherimide, polyphenylenesulfide, polysulfone, and polyethersulfone. Among these, a high density polyethylene film is preferred because of its lower price. The protective film preferably has a thickness of 10 to 50 μm. The protective film may be laminated on the THV or the other fluororesin film by hot pressing. Alternatively, the resin used for the protective film may be co-extruded with the fluororesin into a co-extruded film of, for example, PE/ETFE/THV, and the co-extruded film is laminated on the polyester film.

### EXAMPLES

The present invention will be explained in detail with reference to the following Examples.

Films Used

Polyethylene terephthalate (PET) film: ex Mitsubishi Chemical Co., 50 μm or 100 μm thick, both having a tensile modulus of elasticity in the traverse direction of 5000 N/mm².

Tetrafluoroethylene-hexafluoropropylene-vinylidene fluoride ternary copolymer (THV): 50 wt % of tetrafluoroethylene, 20 wt % of hexafluoropropylene, and 30 wt % of vinylidene fluoride, ex Dyneon Co.

Tetrafluoroethylene-ethylene copolymer (ETFE) film: ex Asahi Glass Co.

Silicone-coated PET film: ex Mitsubishi Chemical Polyester Film Co., MRE(trade name), 50 μm thick.

Measurement of Thickness Difference (R)

Thickness difference of a film was measured by continuously measuring thickness of the film over 10 cm along the machine direction with a FILM THICKNESS TESTER, ex Anritsu Co., provided with a tip of 5 mm in diameter. The measurement was repeated at 10 locations at intervals of 1 centimeter along a direction perpendicular to the machine direction and the results were averaged. Thickness difference in a direction perpendicular to the machine direction was also measured over 10 cm in a similar manner as described above. The measurement was repeated at 10 locations at intervals of 1 centimeter along a machine direction and the results were averaged.

Preparation of Films

The films as shown in Table 1 were prepared by co-extruding THV and ETFE through a T-die at a temperature of 200 degrees C. and laminated on a PET film which had been coated with an adhesive. The films of Comparative Examples 1 and 2 were prepared by dry lamination.

Methods of Evaluation

(1) Each film was visually observed for entrapped bubbles or foreign bodies having a diameter of 300 μm or larger. The film was rated as “B” when a bubble or foreign body was observed, and rated as “A” when no bubble or foreign body was observed.

(2) A 30 μm thick coating film of a polyimide resin was formed on each film and evaluated for a handling property in the application of polyimide, a release property of the coating film, R of the coating film, and contamination on the coating film surface according to the following criteria. The results are as shown in Table 1.

a. Handling Property

The film which was easy to handle without creasing was rated as “A”; one showed a few creases, “B”; and one which was creasy and difficult to handle, “C”.

b. Release Property

The film which could be easily peeled off by hand was rated as “A”, otherwise rated as “B.”

c. Thickness Difference (R) of the Coating Film

The coating film which had R of 5 μm or smaller was rated as “A” and one having R greater than 5 μm, “B”.

d. Contamination on the Coating Film Surface

The surface of the coating film was visually observed for contamination. When contamination was found, the carrier film was rated as “B”; and when not found, “A”.

TABLE 1

| | | | | | Foreign bodies | R of the | Contamination |
|---|---|---|---|---|---|---|---|
| | | | Handling | Release | 300 μm φ or | Coating | on the Coating |
| | Film Structure | R | Property | Property | larger | Film | Film |
| Example 1 | PET(50 μm)/THV(3 μm)/ETFE(3 μm) | A | A | A | A | A | A |
| Example 2 | PET(100 μm)/THV(3 μm)/ETFE(3 μm) | A | A | A | A | A | A |
| Example 3 | PET(100 μm)/THV(3 μm)/FEP(3 μm) | A | A | A | A | A | A |
| Comparative | PET(50 μm)/ETFE(3 μm) | A | A | A | B | A | A |
| Example 1 | | | | | | | |
| Comparative | PET(100 μm)/ETFE(3 μm) | A | A | A | B | A | A |
| Example 2 | | | | | | | |
| Comparative | ETFE(50 μm) | B | C | A | A | B | A |
| Example 3 | | | | | | | |
| Comparative | ETFE(100 μm) | B | B | A | A | B | A |
| Example 4 | | | | | | | |
| Comparative | silicone coated PET(50 μm) | A | A | A | A | A | B |
| Example 5 | | | | | | | |

### INDUSTRIAL APPLICABILITY

As described above, the present film can be prepared by extrusion lamination, and has a good handling and release properties. The present film is suitable as a carrier film to give a coating film with a uniform thickness without contamination.

1. A laminated film comprising a drawn polyester film and a tetrafluoroethylene-hexafluoropropylene-vinylidene fluoride ternary copolymer film laminated on at least one side of the drawn polyester film.

2. The laminated film according to claim 1, wherein a film comprising another fluororesin than the ternary copolymer is further laminated on said ternary copolymer film.

3. The laminated film according to claim 2, wherein said film comprising the other fluororesin is a film comprising a tetrafluoroethylene-ethylene copolymer or a tetrafluoroethylene-hexafluoropropylene copolymer.

4. The laminated film according to claim 1 or 2, wherein the laminated film has a difference between a maximum thickness and a minimum thickness, R, of 5 μm or smaller, said thickness being measured along a 10 cm-long line starting at an arbitrary point on a surface of the laminated film with a continuous-mode thickness meter provided with a tip having a diameter of 5 mm.

5. The laminated film according to claim 1 or 2, wherein said drawn polyester film is a polyethylene terephthalate film having a thickness of from 5 to 1,000 μm and said ternary copolymer film has a thickness of from 2 to 10 μm.

6. The laminated film according to claim 3, wherein said film comprising the other fluororesin is a film comprising a tetrafluoroethylene-hexafluoropropylene copolymer and having a thickness of from 2 to 10 μm.

7. The laminated film according to claim 1 or 2, wherein the film has a total thickness of from 10 to 300 μm.

8. The laminated film according to claim 1, wherein a polyethylene film, polypropylene film, or polyester film is further laminated on said ternary copolymer film.

9. The laminated film according to claim 2, wherein a polyethylene film, polypropylene film, or polyester film is further laminated on the film comprising the other fluororesin.

10. A carrier film for manufacturing and supporting a coating film comprising the laminated film according to claim 1 or 2.

11. A method for preparing a laminated film, comprising a step of extrusion laminating a tetrafluoroethylene-hexafluoropropylene vinylidene fluoride ternary copolymer on a drawn polyester film.

12. The method according to claim 11, wherein the ternary copolymer is co-extruded together with another fluororesin than the ternary copolymer and laminated on the drawn polyester.
